(19) United States
(12) Patent Application Publication
(10) Pub. No.: US 2008/0220838 A1
(43) Pub. Date: Sep. 11, 2008

(54) Gaming Method And Gaming Machine Accepting Side Bet

(75) Inventor: Kazuo OKADA, Tokyo (JP)

Correspondence Address: NDQ&M WATCHSTONE LLP, 1300 EYE STREET, NW, SUITE 1000 WEST TOWER, WASHINGTON, DC, 20005, US

(73) Assignee: ARUZE GAMING AMERICA, INC., Las Vegas, NV (US)

(21) Appl. No.: 11/877,920

(22) Filed: Oct. 24, 2007

Related U.S. Application Data
(60) Provisional application No. 60/905,582, filed on Mar. 8, 2007.

(51) Int. Cl. A63F 13/00

(52) U.S. Cl. 463/13

(57) ABSTRACT

A playing method of a card game according to the present invention comprises the steps of: (a) dealing a predetermined number of cards to a plurality of players as player's cards and dealing a predetermined number of cards to a banker as banker's cards; (b) placing a side BET different from a normal BET; (c) determining whether or not a hand of the player's cards dealt to a player who has placed the side BET, satisfies a predetermined condition; (d) when determining, in the step (c), that the number of the players determined to have hands of the player's cards which satisfy the predetermined condition is one, determining a normal payout value which is determined based on this hand and the side BET, as a payout to be offered to the player; and (e) when determining, in the step (c), that the number of the players determined to have hands of the player's cards which satisfy the predetermined condition is equal to or more than two, determining payouts to be offered to those players, so as to make a total sum of the payout values to those players be smaller than a total sum of normal payout values to those players.

### CROSS-REFERENCE TO RELATED APPLICATIONS

This application claims benefit of priority based on U.S. Provisional Patent Application No. 60/905,582 filed on Mar. 8, 2007. The contents of this application are incorporated herein by reference in their entirety.

### BACKGROUND OF THE INVENTION

1. Field of the Invention

The present invention relates to a gaming method and a gaming machine accepting side BETs.

2. Discussion of the Background

Conventionally, there have been gaming machines capable of accepting side BETs different from normal BETs. For example, in blackjack, when an upcard is an “A” card out of dealer's two cards, a player can place a side BET called insurance, in addition to a normal BET. In a case of placing insurance, the player adds the wager by half of an initial wager. When the dealer's hand is “Natural 21”, the amount twice the value of the side BET (insurance) is paid out. Further, for example, in Caribbean stud porker, a side BET is cumulatively accumulated as a progressive jackpot. When a player places a side BET in addition to an ante (a normal BET), he or she can acquire a part of or the entire progressive jackpot, according to the established hand. A game capable of accepting side BETs of this kind is disclosed in, for example, U.S. Pat. No. 6,789,801, U.S. Pat. No. 5,711,525 and U.S. Pat. No. 6,874,786.

It is an object of the present invention to provide a gaming method and a gaming machine capable of accepting side BETs, thus exhibiting new entertainment.

The contents of U.S. Pat. No. 6,789,801, U.S. Pat. No. 5,711,525 and U.S. Pat. No. 6,874,786 are incorporated herein by reference in their entirety.

### SUMMARY OF THE INVENTION

According to the present invention, there is provided a playing method of a card game having the following structure.

Namely, the above mentioned playing method of a card game is a playing method of a card game comprising the steps of: (a) dealing a predetermined number of cards to a plurality of players as player's cards and dealing a predetermined number of cards to a banker as banker's cards; (b) placing a side BET different from a normal BET; (c) determining whether or not a hand of the player's cards dealt to a player who has placed the side BET, satisfies a predetermined condition; (d) when determining, in the step (c), that the number of the players determined to have hands of the player's cards which satisfy the predetermined condition is one, determining a normal payout value which is determined based on this hand and the side BET, as a payout to be offered to the player; and (e) when determining, in the step (c), that the number of the players determined to have hands of the player's cards which satisfy the predetermined condition is equal to or more than two, determining payouts to be offered to those players, so as to make a total sum of the payout values to those players be smaller than a total sum of normal payout values to those players.

Further, it is preferable that the playing method of a card game according to the present invention have the following structure.

The predetermined condition is a condition that the strength of the hand of player's cards should be equal to or higher than a standard predetermined in an order of the hand strength, and the step (e) is a step of, when determining, in the step (c), that the number of the players determined to have hands of player's cards which satisfy the predetermined condition is equal to or more than two, determining the player having the strongest hand by comparing hands of those players based on the order of the hand strength, and determining the normal payout value which is determined based on this hand and the side BET, as the payout to be offered to the player.

Further, it is preferable that the playing method of a card game according to the present invention have the following structure.

The playing method of a card game comprises a step of (b′) determining whether or not the banker should fold, after the step (b) and before the step (c), and the step (c) is a step of: determining whether or not the hand of the player's cards dealt to the player who has placed the side BET, satisfies the predetermined condition, on condition that a determination is made in the step (b′) that the banker should fold.

Further, it is preferable that the playing method of a card game according to the present invention have the following structure.

The playing method of a card game comprises the steps of: (a′) placing an entry-fee BET before the step (a); and (b″) offering a payout to a player who has not placed the side BET, based on the inputted entry-fee BET, when determining that the banker should fold in the step (b′), after the step (b′) and before the step (c).

Further, there is provided a gaming machine having the following structures according to the present invention. Namely, the above mentioned gaming machine is a gaming machine comprising: a display capable of displaying a plurality of cards; a plurality of input devices capable of being operated by a plurality of players; and a controller. The controller is programmed to conduct the processing of: (a) displaying a predetermined number of player's cards and a predetermined number of banker's cards to the display; (b) accepting an input of a side BET different from a normal BET from each of the input devices; (c) determining whether or not a hand of the player's cards of a player who has inputted the side BET, satisfies a predetermined condition; (d) when determining, in the step (c), that the number of the players determined to have hands of the player's cards which satisfy the predetermined condition is one, determining a normal payout value which is determined based on this hand and the side BET, as a payout to be offered to the player; and (e) when determining, in the step (c), that the number of the players determined to have hands of the player's cards which satisfy the predetermined condition is equal to or more than two, determining payouts to be offered to those players, so as to make a total sum of the payouts to be offered to those players be smaller than a total sum of normal payout values to those players.

Further, it is preferable that the gaming machine of the present invention have the following structure.

The predetermined condition is a condition that the strength of the hand of player's cards should be equal to or higher than a standard predetermined in an order of the hand strength, and the processing (e) is a processing of: when determining, in the processing (c), that the number of the players determined to have hands of player's cards which satisfy the predetermined condition is equal to or more than two, determining the player having the strongest hand by comparing the hands of the players based on the order of the hand strength, and determining the normal payout value which is determined based on this hand and the side BET, as the payout to be offered to the player.

Further, it is preferable that the gaming machine of the present invention have the following structure.

The controller is further programmed to conduct a processing of: (b′) determining whether or not the banker should fold, after the processing (b) and before the processing (c), and the processing (c) is a processing of: determining whether or not the hand of the player's cards of the player who has inputted the side BET, satisfies the predetermined condition, on condition that a determination is made in the processing (b′) that the banker should fold.

Further, it is preferable that the gaming machine of the present invention have the following structure.

The controller is further programmed to conduct the processing of: (a′) accepting an input of an entry-fee BET, before the processing (a); and (b″) offering a payout to a player who has not inputted the side BET, based on the inputted entry-fee BET, when determining that the banker should fold in the processing (b′), after the processing (b′) and before the processing (c).

### BRIEF DESCRIPTION OF THE DRAWINGS

FIG. 1 is a flow chart illustrating a game execution processing routine conducted in a gaming machine according to one embodiment of the present invention.

FIG. 2 is a perspective view schematically illustrating the external structure of the gaming machine according to the present embodiment.

FIG. 3 is a perspective view schematically illustrating the external structure of a station included in the gaming machine illustrated in FIG. 2.

FIG. 4 is a view illustrating an exemplary image which is displayed to a front display included in the gaming machine.

FIG. 5 is a view illustrating an exemplary image which is displayed to a liquid crystal display included in a station.

FIG. 6 is a block diagram illustrating the internal structure of the gaming machine illustrated in FIG. 2.

FIG. 7 is a block diagram illustrating the internal structure of a station included in the gaming machine illustrated in FIG. 2.

### DESCRIPTION OF THE EMBODIMENTS

There will be described an embodiment of the present invention with regard to the case where Caribbean stud porker is played as a card game. First, the rule of Caribbean stud porker, which is played in the present embodiment, will be described.

In Caribbean stud porker, a banker, and a single player or a plurality of players play a game against each other, using a single set of playing cards (52 cards). Winning or losing of a game is determined by comparing the hand of five cards dealt to the banker with the hand of five cards dealt to the player to determine which of them is stronger than the other. As hands of Caribbean stud porker, hands of poker are employed. Namely, as hands of Caribbean stud poker, there are Royal Flush, Straight Flush, Four of a Kind, Full House, Flush, Straight, Three of a Kind, Two pair, One pair and No Pair, in the order of strength. The strength of a hand “No pair” is determined depending on the strength of a high card therein. The high card is the highest card in the strength ranking of cards among the five cards. As the strength ranking of cards, an ace is the highest, followed by K, Q, j, 10 . . . 2, in descending order. When two hands are equal in the strength of the high cards, the stronger hand of the two is determined based on the strength of the second highest cards in the strength ranking of cards. Hereinafter, the strength ranking of hands is predetermined following the same procedure. This strength ranking of hands corresponds to the order of the hand strength according to the present invention.

More specifically, a game progresses as follows. First, an ante BET and a side BET (1 dollar, in the present embodiment) are accepted. Then, five cards are dealt to each player who has placed an ante BET and the banker. The ante BET corresponds to an entry-fee BET according to the present invention. Each player selects either of the actions to take, “surrender” or “call bet”, on seeing the cards dealt to him or her. Selecting “surrender” indicates that the player passes the game without playing against the banker. When selecting “surrender”, the player loses an amount corresponding to the ante BET and the side BET. On the other hand, selecting “call bet” indicates that the player plays the game against the banker. When selecting “call bet”, the player newly bets the value twice the value of the ante BET, as a call BET. Hereinafter, selecting either of “surrender” or “call bet” by the player will be referred to as a BET selection. When the BET selections by all the players in the game finish, whether or not the game between the banker and the players should be played, is determined following the below-mentioned procedure.

First, when a strength of the banker's hand is lower than the strength of “A-K-*-*-*”, the banker passes the game as he or she can not start the game against the player. Here, “A-K-*-*-*” indicates a combination of five cards, wherein “*” may indicate any card. However, “A-K-*-*-*” as a standard to determine whether or not the banker should pass the game, may not be a combination which forms a hand equal to or stronger than One Pair. Namely, a hand having a strength lower than the strength of “A-K-*-*-*” refers to a hand having a strength equal to or lower than the strength of “A-Q-J-10-9”. Further, the banker's passing the game as described above corresponds to “fold” according to the present invention. Hereinafter, also in the present embodiment, the banker's passing the game following the above-mentioned procedure will be referred to as “fold”. When the banker folds, the player newly acquires the value corresponding to the ante BET, on condition that no side BET is placed. However, the call BET becomes invalid and the betted amount is paid back in its entirety.

On the other hand, when a strength of the banker's hand is equal to or higher than the strength of “A-K-*-*-*”, a game between the banker and the player is executed. The result of winning or losing of the game is determined by comparing the banker's hand with the player's hand, based on the above-mentioned strength ranking of hands in poker. When winning or losing of the game results in winning of the player, a payout is offered based on the value of the ante BET and the call BET, and the result of the game. Here, the payout for the ante BET is the same value as the value of the ante BET. On the other hand, for the payout for the call BET, rates are predetermined in accordance with the strength of hands. The predetermined rates are as follows. Namely, the rate is one to one on One Pair. The rate is two to one on Two Pair. The rate is three to one on Three of a Kind. The rate is four to one on Straight. The rate is five to one on Flush. The rate is seven to one on Full House. The rate is twenty to one on Four of a Kind. The rate is fifty to one on Straight Flush. The rate is one hundred to one on Royal Flush.

When winning or losing of the game results in a loss of the player, the player loses the value corresponding to the ante BET and the call BET.

There has been described the general rule of Caribbean Stud Poker. In the present embodiment, a following procedure is further employed for the player who has placed a side BET, when the banker folds.

First, whether or not the hand of each player who has placed the side BET is equal to or higher than Full House, is determined. Full House corresponds to a standard predetermined in an order of the hand strength according to the present invention. Further, player's having the hand equal to or higher than Full House corresponds to a predetermined condition according to the present invention.

When the number of the players having hands equal to or higher than Full House is one, a payout is offered to this player based on the strength of this player's hand. In the present embodiment, the resource of payout relating to the side BET is coins betted as the side BET. The coins betted as the side BET are accumulated as a cumulative pot value. The value of the payout is determined following a method predetermined based on the hand strength. More specifically, when the player's hand is Royal Flush, an entire value of the cumulative pot value is paid out to the player. When the player's hand is Straight Flush, 10% value of the cumulative pot value is paid out to the player. When the player's hand is Four of a Kind, 500 dollars are paid out to the player. When the player's hand is Full House, 100 dollars are paid out to the player. The value of the payout determined based on the hand strength as described above, corresponds to a normal payout value according to the present invention. Also in the present embodiment, the value of the payout determined as described above will be referred to as a normal payout value.

On the other hand, when the number of the players having hands equal to or higher than Full House is equal to or more than two, the player having the strongest hand is determined by comparing the strength of these players' hands. Then, the payout is offered to this player, based on the strength of this player's hand. The value of the payout is the above-mentioned normal payout value which is the same as the payout value when the number of the players having hands equal to or higher than Full House is one. When no player has the hand equal to or higher than Full House, no payout relating to the side BET is offered.

There has been described the rule of Caribbean Stud Poker executed in the present embodiment. Hereinafter, the present embodiment will be described with reference to the drawings. Further, in each embodiment, there will be described a case where a dealer serves as a banker.

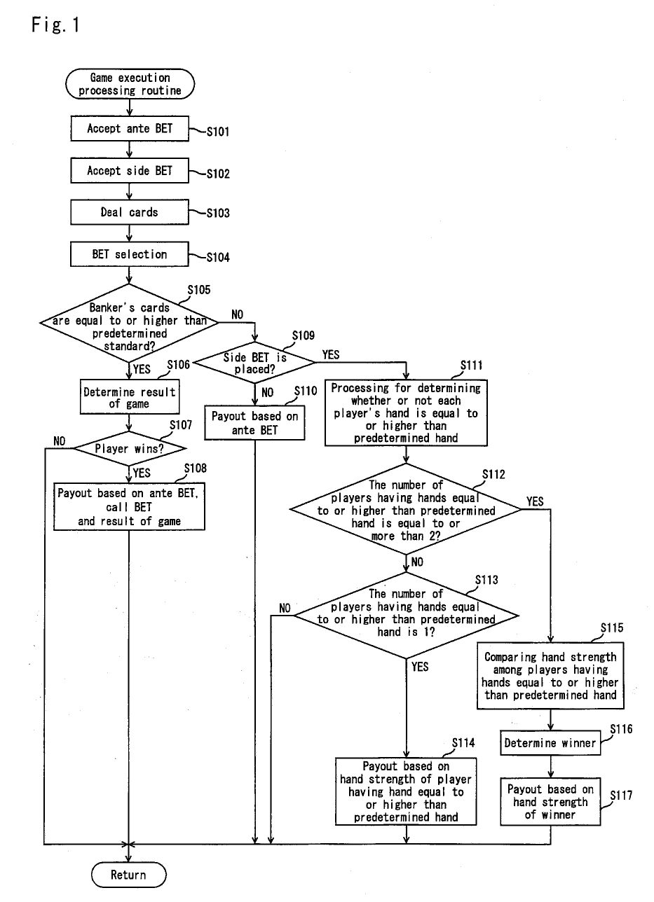

First, the present invention will be described with reference to FIG. 1.

FIG. 1 is a flow chart illustrating a game execution processing routine conducted in a gaming machine according to an embodiment of the present invention.

The gaming machine according to the present embodiment comprises a main control portion and a plurality of stations, and each station includes a microcomputer. The main control portion and the microcomputer form a controller included in the gaming machine of the present invention. The processing illustrated in FIG. 1 is processing conducted by the control portion and the microcomputer.

First, in each station included in the gaming machine, inputs of an ante BET and a side BET are accepted (step S101 and S102). Then, five cards are dealt to each player who has inputted an ante BET and the banker (step S103). Here, the term “dealing” refers to displaying images of cards to a display included in the gaming machine. After the dealing of cards, each player conducts an above-described BET selection (step S104). When BET selections by all players in the game finish, the main control portion included in the gaming machine determines whether or not the hand strength of the banker's cards is equal to or higher than the strength of “A-K-*-*-*” (step S105). When the hand strength of the banker's cards is equal to or higher than the strength of “A-K-*-*-*”, the main control portion determines the result of the game by comparing the banker's cards with the player's cards (step S106). When the game results in winning of the player, the main control portion offers a payout to the player based on the ante BET, the call BET, and the result of the game (steps S107 and S108). When the hand strength of the banker's cards is lower than the strength of “A-K-*-*-*” (step S105: No), the main control portion offers the payout to each player playing the game at the station at which no side BET is inputted (step S109: No), based on the ante BET only (step S110).

On the other hand, when the hand strength of the banker's cards is lower than the strength of “A-K-*-*-*” (step S105: No), the main control portion determines whether or not the hand of each player playing the game at the station at which the side BET is inputted (step S109: Yes), is equal to or higher than Full House (step S111). Then, the main control portion determines whether or not two or more players have hands equal to or higher than Full House (step S112).

When the number of the players having hands equal to or higher than Full House is less than two (step S112: No), the main control portion, in a case where the number of the players having hands equal to or higher than Full House is one (step S113: Yes), pays out a normal payout value to this player based on the strength of this player's hand (step S114). On the other hand, when no player has the hand equal to or higher than Full House (step S113: No), the main control portion ends the present subroutine, without offering the payout.

On the other hand, when the number of the players having hands equal to or higher than Full House is equal to or more than two (step S112: Yes), the main control portion compares the strength of hands among the players having hands equal to or higher than Full House (step S115), and determines the player having the strongest hand to be a winner (step S116). Then, the main control portion pays out the normal payout value to the player determined to be the winner, based on the strength of this player's hand (step S117).

FIG. 1 will be described in more detail later again.

Next, there will be described the gaming machine 1 according to the present embodiment.

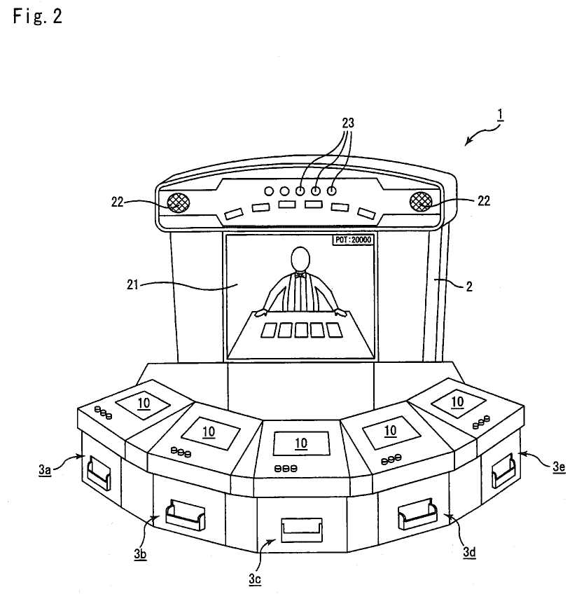

FIG. 2 is a perspective view schematically illustrating the external structure of the gaming machine according to the present embodiment.

As illustrated in FIG. 2, the gaming machine 1 is basically comprised of a main monitor 2 and five stations 3 (stations 3a to 3e). Further, while, in the present embodiment, there will be described a case where the gaming machine 1 comprises a plurality of (five) stations 3, the number of stations included in the gaming machine is not particularly limited, in the present invention.

At the center portion of the main monitor 2, there is provided a front display 21 for displaying images indicating a dealer and cards. The front display 21 corresponds to a display according to the present invention. Further, on the upper side of the main monitor 2, there are provided a plurality of speakers 22 for outputting music and an effect sound along with the progression of a game executed in the gaming machine 1 and a plurality of LEDs 23 which are lighted during various types of effects.

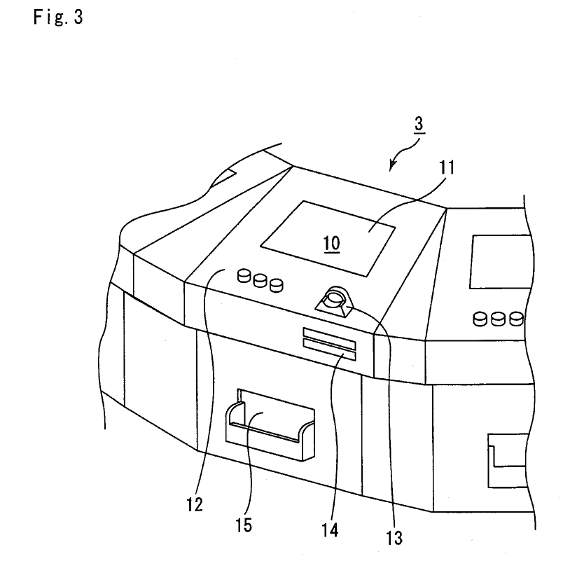

FIG. 3 is a perspective view schematically illustrating the external structure of a station included in the gaming machine illustrated in FIG. 2.

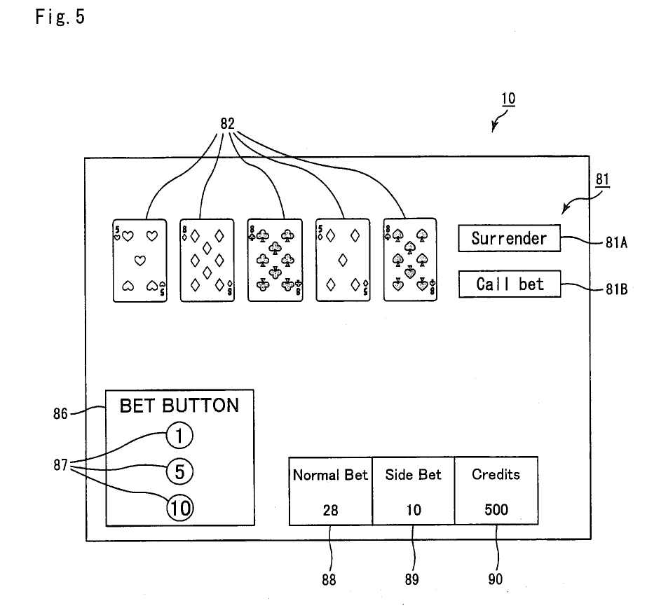

As illustrated in FIG. 3, at the center of the upper surface of the station 3, there is provided a liquid crystal display 10 for displaying an image relating to an operation (see FIG. 5) and the like as will be described later. The liquid crystal display 10 corresponds to a display according to the present invention. Further, on the upper surface of the liquid crystal display 10, there is provided a touch panel 11 for inputting an operation for a BET and the like. The touch panel 11 corresponds to an input device according to the present invention.

In front of the liquid crystal display 10, there are provided a plurality of operation buttons 12 for performing a payout operation, and a coin insertion slot 13 for inserting a coin or a medal thereto.

At the right end of the upper portion of the front surface of the station 3, there is provided a bill insertion slot 14 for inserting a bill thereto. Below the bill insertion slot 14, there is provided a coin payout exit 15 for paying out the number of coins or medals corresponding to the accumulated credit to the player, when a payout operation is performed.

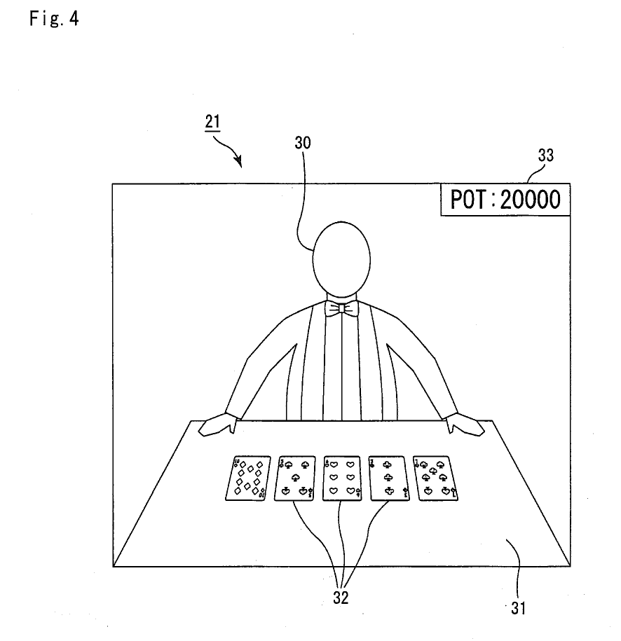

FIG. 4 is a view illustrating an exemplary image which is displayed to the front display included in a gaming machine.

As illustrated in FIG. 4, the front display 21 displays a dealer image 30 indicating a dealer (banker), a table image 31 indicating a table, and card images 32 indicating banker's cards. All the card images 32 are displayed facing down, when cards are dealt to the dealer. When BET selections by all the players in the game finish, the card images 32 are displayed facing up. Further, at the right end of the upper portion of the front display 21, there is provided a value-of-cumulative-pots display portion 33 for displaying the total value of coins betted as the side BET.

FIG. 5 is a view illustrating an exemplary image which is displayed to a liquid crystal display included in a station.

As illustrated in FIG. 5, at the right side of the upper portion of the liquid crystal display 10, there are provided BET selection buttons 81. The BET selection buttons 81 comprises two kinds of buttons, surrender button 81A and call-bet button 81B. Surrender button 81A is a button for inputting a command to select “surrender” as a BET selection. Call-bet button 81B is a button for inputting a command to select “call bet” as a BET selection. The player can conduct a BET selection by operating each button through touch panel 11. At the left side of BET selection buttons 81, there are displayed card images 82 indicating the player's cards with their faces up.

Under the card images 82, there is provided a BET button display portion 86. To the BET button display portion 86, there are displayed BET buttons 87 for inputting the number of BETs. The player can input the number of normal BETs and the number of side BETs by operating the BET buttons 87 through the touch panel 11.

At the right side of the BET button display portion 86, there is provided a number-of-normal-BETs display portion 88 for displaying the number of coins being betted as a normal BET. FIG. 5 illustrates that 28 coins are betted. Further, in order to input a BET of 28 coins, the player can operate a “10” BET button 87 twice, “5” BET button 87 once and a “1” BET button 87 three times.

At the right side of the number-of-normal-BETs display portion 88, there is provided a number-of-side-BETs display portion 89 for displaying the number of coins betted as a side BET. FIG. 5 illustrates that 1 coin (corresponding to 1 dollar) are betted.

At the right side of the number-of-side-BETs display portion 89, there is provided the number-of-credits display portion 90. FIG. 5 illustrates that 500 coins are being credited.

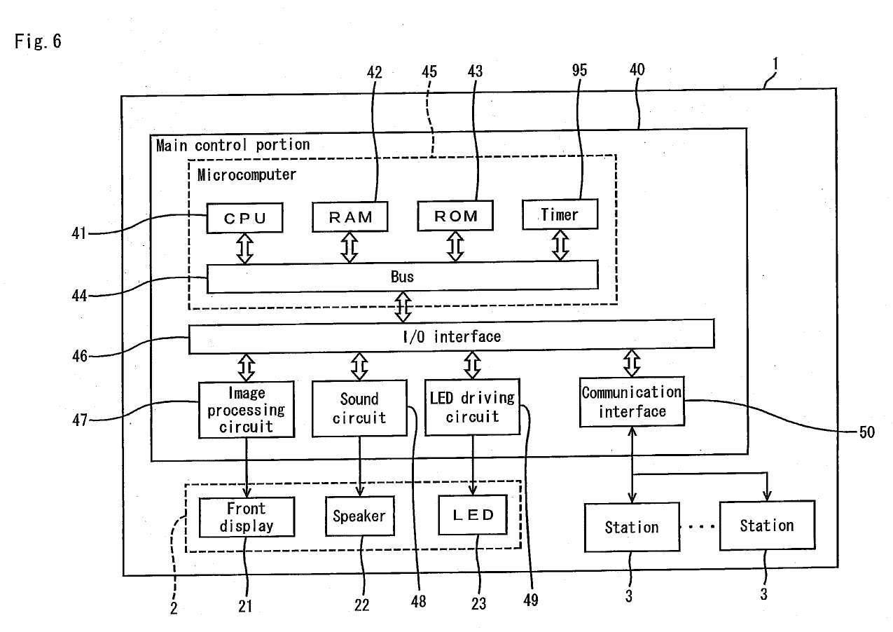

FIG. 6 is a block diagram illustrating the internal structure of the gaming machine illustrated in FIG. 2.

As illustrated in FIG. 6, the main control portion 40 provided in the gaming machine 1 comprises a microcomputer 45 as the core, which basically includes a CPU 41, a RAM 42, a ROM 43, a timer 95, and a bus 44 for transferring data mutually among these devices. The main control portion 40 corresponds to a controller according to the present invention.

The ROM 43 stores various types of programs for conducting processing necessary for controlling the gaming machine 1, a data table and the like. The RAM 42 is a memory for temporarily storing various types of data calculated in the CPU 41. Further, the timer 95 conducts time measurement.

Further, the CPU 41 is connected to an image processing circuit 47, a sound circuit 48, an LED driving circuit 49 and a communication interface 50 through an I/O interface 46.

The front display 21 included in the main monitor 2 is connected to the image processing circuit 47. The plurality of speakers 22 included in the main monitor 2 are connected to the sound circuit 48. The LEDs 23 included in the main monitor 2 are connected to the LED driving circuit 49. The five stations 3 are connected to the communication interface 50.

The CPU 41 progresses a game (Caribbean stud poker) which is executed in the gaming machine 1, based on game programs (including a game program for Caribbean stud poker) stored in the ROM 43 and various types of signals received from the stations 3. Further, the CPU 41 displays an image to the front display 21, outputs sound from the plurality of speakers 22 and lights the LEDs 23, based on the above-mentioned game programs. Further, the CPU 41 transmits various types of signals to the respective stations 3, based on the above-mentioned game programs.

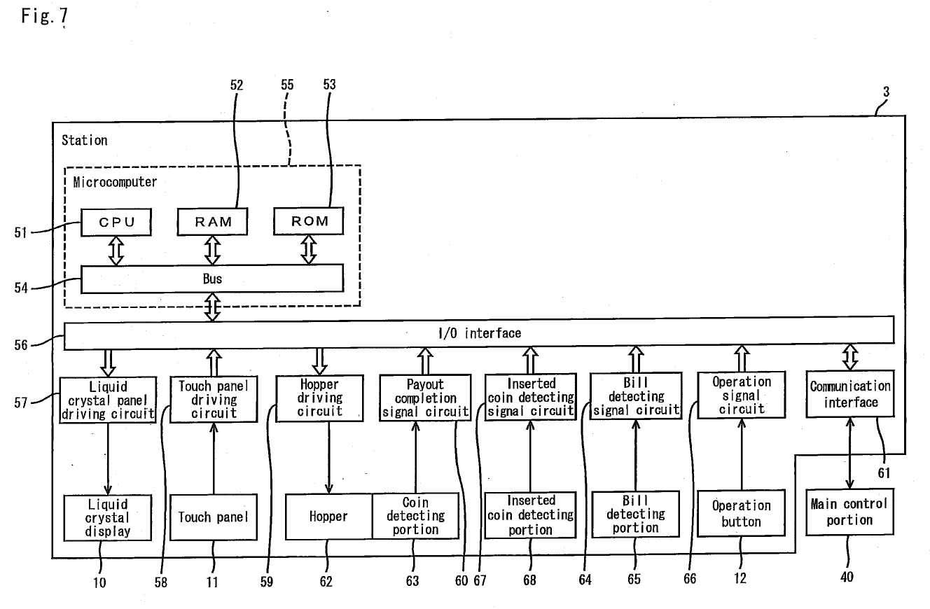

FIG. 7 is a block diagram illustrating the internal structure of a station included in the gaming machine illustrated in FIG. 2.

As illustrated in FIG. 7, the station 3 includes, as the core, a microcomputer 55 which is basically comprised of a CPU 51, a RAM 52, a ROM 53, and a bus 54 for transferring data mutually among these devices.

The ROM 53 stores various types of programs for conducting processing necessary for controlling the station 3, data tables and the like. Further, the RAM 52 temporarily stores the number of credits currently accumulated in the station 3 and various types of data calculated in the CPU 51.

Further, the CPU 51 is connected to a liquid crystal panel driving circuit 57, a touch panel driving circuit 58, a hopper driving circuit 59, a payout completion signal circuit 60, an inserted-coin detecting signal circuit 67, a bill detecting signal circuit 64, an operation signal circuit 66 and a communication interface 61, through an I/O interface 56.

A liquid crystal display 10 is connected to the liquid crystal panel driving circuit 57. A touch panel 11 is connected to the touch panel driving circuit 58. A hopper 62 is connected to the hopper driving circuit 59. A coin detecting portion 63 is connected to the payout completion signal circuit 60. An inserted-coin detecting portion 68 is connected to the inserted-coin detecting signal circuit 67. A bill detecting portion 65 is connected to the bill detecting signal circuit 64. An operation button 12 is connected to the operation signal circuit 66.

The hopper 62 is provided inside the station 3 and pays out a coin through the coin payout exit 15 based on a control signal outputted from the CPU 51.

The coin detecting portion 63 is provided inside the coin payout exit 15 and transmits a signal to the CPU 51 on detecting a predetermined number of coins being paid out through the coin payout exit 15.

The inserted-coin detecting portion 68, on detecting a coin being inserted from the coin insertion slot 13, detects the value of the coin and transmits a detecting signal indicative of the detected value to the CPU 51. The detected value of the coin is counted regarding a predetermined value defined as 1 credit and is stored in the RAM 52.

The bill detecting portion 65, on accepting a bill, detects the value of the bill and transmits a detecting signal indicative of the detected value to the CPU 51. The detected value of the bill is counted regarding a predetermined value defined as 1 credit and is stored in the RAM 52.

The operation button 12 is a button for performing payout operations, when payout of the coin is determined.

Next, there will be described processing conducted in the gaming machine 1.

FIG. 1 is a flow chart illustrating a game execution processing routine conducted in the gaming machine according to the embodiment of the present invention.

First, in step S101 in FIG. 1, the gaming machine 1 conducts processing relating to the acceptance of the ante BET. More specifically, at first, the CPU 51 in the station 3 accepts an input of an ante BET. This enables the player to input an ante BET through the touch panel 11 included in the station 3. Then, the CPU 51 transmits ante-BET information to the main control portion 40. The ante-BET information is information relates to the ante BET and includes information about whether or not an ante BET is placed and the value of the ante BET. The ante BET is included in normal BET according to the present invention.

Next, in step S102, the gaming machine 1 conducts the processing relating to the acceptance of a side BET. More specifically, first, the CPU 51 in the station 3 accepts an input of the side BET. This enables the player to input the side BET through the touch panel 11 included in the station 3. Then, the CPU 51 transmits side BET information to the main control portion 40. The side BET information is information relating to the side BET and including information about whether or not the side BET is placed and the value of the side BET. On receiving the side BET information, the CPU 41 in the main control portion 40 sets a side BET flag, when determining that a side BET is inputted, based on the received side BET information. The side BET flag is a flag which is set when a side BET is inputted.

The processing conducted by the main control portion 40 and the microcomputer 55 in the station 3 in step S102 corresponds to step (b) placing a side BET different from a normal BET, according to the present invention.

Next, in step S103, the gaming machine 1 conducts processing relating to the dealing of cards to the player and the banker. More specifically, the CPU 41 in the main control portion 40 determines five cards to be dealt to each player and the banker, out of a single set of playing cards, using random numbers. The five cards determined to be dealt to the player correspond to player's cards according to the present invention, while the five cards determined to be dealt to the banker correspond to banker's cards according to the present invention. Further, card images indicative of the five banker's cards are displayed facing down to the front display 21 included in the gaming machine 1. Subsequently, the CPU 41 transmits to-be-dealt cards information to the station 3. The to-be-dealt cards information includes information indicative of the types of the cards determined to be dealt to the player and the banker (ranks and suits [heart, club, spade, diamond]). The CPU 51 in the station 3 displays card images indicative of the five player's cards to a liquid crystal display 10, based on the received to-be-dealt cards information.

The processing conducted by the main control portion 40 and the microcomputer 55 in the station 3 in step S103 corresponds to step (a) dealing a predetermined number of cards to a plurality of players as player's cards and dealing a predetermined number of cards to a banker as banker's cards, according to the present invention.

Next, in step S104, the gaming machine 1 conducts processing relating to a BET selection by the player. More specifically, the CPU 51 in the station 3 accepts the BET selection. In response to the acceptance, the player conducts the BET selection through the touch panel 11. Then, the CPU 51 transmits selection information to the main control portion 40. The selection information is information relating to the BET selection by the player. When the player selects “call bet” as the BET selection, the CPU 51 conducts processing relating to call BET. Namely, the CPU 51 conducts processing for subtracting the value twice the value of the ante BET from the number of credits accumulated in the RAM 52 and determining this value as the value of call BET. The call BET is included in normal BET according to the present invention.

Next, in step S105, the gaming machine 1 determines whether or not the banker should fold. More specifically, the CPU 41 in the main control portion 40 determines whether or not the hand strength of the banker's cards is equal to or higher than the strength of “A-K-*-*-*”. When determining that the hand strength of the banker's cards is equal to or higher than the strength of “A-K-*-*-*”, the gaming machine 1 shifts the processing to step S106. On the other hand, when determining that the hand strength of the banker's cards is lower than the strength of “A-K-*-*-*”, the gaming machine 1 shifts the processing to step S109.

The processing conducted by the main control portion 40 in step S105 corresponds to step (b′) determining whether or not the banker should fold, according to the present invention.

When determining that the hand strength of the banker's cards is equal to or higher than the strength of “A-K-*-*-*” (step S105: YES), the gaming machine 1 conducts processing for determining the result of the game (step S106). More specifically, the CPU 41 in the main control portion 40 determines winning or losing of the game by comparing the hand of the banker's cards with the hand of the player's cards based on the strength ranking of hands in poker.

Next, in step S107, the gaming machine 1 determines whether or not the result of the game determined in step S106 is winning of the player. When determining that the result of the game is a loss of the player, the gaming machine 1 ends the present subroutine. On the other hand, when determining that the result of the game is winning of the player (including a tie), the gaming machine 1 shifts the processing to step S108.

In step S108, the gaming machine 1 conducts processing relating to the payout.

More specifically, the CPU 41 in the main control portion 40 transmits ante-BET payout information and call BET payout information to the station 3. The ante BET payout information is information indicative of the value of a credit (currency value) to be paid out for the ante BET. The call BET payout information is information indicative of the value of a credit (currency value) to be paid out for the call BET. More specifically, the CPU 41 transmits, as ante BET payout information, information indicative of the credit value twice the value of the ante BET. Further, the CPU 41 transmits, as call BET payout information, information indicative of the credit value resulting from the multiplication of the value of the call BET by the rate predetermined in accordance with the strength of hands. Further, when the result of the game determined in step S106 is a tie, the CPU 41 transmits information, as ante BET payout information, indicative of the same credit value as the value of the ante BET and transmits information, as call BET payout information, indicative of the same credit value as the value of the call BET.

On receiving the ante BET payout information and the call BET payout information transmitted from the CPU 41, the CPU 51 in the station 3 stores, in the RAM 52, credit data based on the ante BET payout information and the call BET payout information. Then, the CPU 51 pays out credits based on the ante BET payout information and the call BET payout information.

After conducting the processing in step S108, the gaming machine 1 ends the present subroutine.

When determining, in step S105, that the hand strength of the banker's cards is lower than the strength of “A-K-*-*-*” (step S105: NO), the gaming machine 1 determines whether or not the side BET has been inputted at each station 3 during the reception of the side BET in step S102 (step S109). More specifically, the CPU 41 in the main control portion 40 determines whether or not the side BET flag is set in each station 3. With regard to the station 3 determined that no side BET is inputted thereto, the gaming machine 1 shifts the processing to step S110. On the other hand, with regard to the station 3 determined that the side BET is inputted thereto, the gaming machine 1 shifts the processing to step S111.

For the station 3 determined, in step S109, that no side BET is inputted (step S109: NO), the gaming machine 1 conducts processing relating to the payout (step S110). More specifically, the CPU 41 in the main control portion 40 transmits, as ante BET payout information, information indicative of the credit value twice the value of the ante BET.

On receiving the ante BET payout information transmitted from the CPU 41, the CPU 51 in the station 3 stores, in the RAM 52, credit data based on the ante BET payout information. Then, the CPU 51 pays out the credit based on the ante BET payout information.

Further, as previously described, in step S110, different from step S108, no processing relating to the payout for the call BET is conducted. Namely, the CPU 41 transmits no call BET payout information to the station 3 and, also, the CPU 51 pays out no credits based on call BET payout information.

The processing conducted in step S110, by the main control portion 40 and the microcomputer 55 in the station 3 corresponds to the step (b″) offering a payout to the player who has not placed the side BET, based on the inputted entry-fee BET, when the step (b′) results in the determination that the banker should fold, according to the present invention.

As described above, in the present embodiment, when the banker folds, the payout based on the ante BET are offered only to the station 3 to which no side BET is inputted. However, in the present invention, when the banker folds, the payout based on the ante BET may also be offered to the station 3 to which the side BET is inputted.

After conducting the processing in step S110, the gaming machine 1 ends the present subroutine.

With regard to the station 3 determined, in step S109, that the side BET is inputted thereto (step S109: Yes), the gaming machine 1 determines whether or not the hand of the player's cards possessed by the player playing the game at each station 3, is equal to or higher than a predetermined hand (Full House) (step S111). More specifically, the CPU 41 in the main control portion 40 determines whether or not the hand of the five cards displayed to the liquid crystal display 10 included in each station 3, is equal to or higher than Full House, based on the to-be-dealt cards information transmitted in step S103 and the above-described strength ranking of the hands in poker.

The processing conducted by the main control portion 40 in step S111 corresponds to the step (c) determining whether or not the hand of said player's cards dealt to the player who has placed the side BET, satisfies a predetermined condition, according to the present invention.

In the present embodiment, the condition that the hand of the player's cards should be equal to or higher than Full House is employed, as the predetermined condition according to the present invention. Further, Full House corresponds to a standard predetermined in an order of the hand strength according to the present invention.

However, the standard predetermined in the order of the hand strength relating to the predetermined condition according to the present invention is not limited to Full House. For example, the standard predetermined in the order of the hand strength relating to the predetermined condition according to the present invention may be Flush and the like, or also may be designed as appropriate. Further, the predetermined condition according to the present invention is not necessarily required to be the condition that the hand of the player's cards should be “equal to or higher than” the predetermined standard. The predetermined condition according to the present invention may be the condition that the hand of the player's cards should be any one of a plurality of hands predetermined in the strength ranking of hands in poker. For example, the predetermined condition according to the present invention may be the condition that the hand of the player's cards should be any one of Royal Flush, Four of a kind, and Flush.

Further, in the present embodiment, the processing in step S111 is conducted only when the banker folds. However, step (c) according to the present invention may be also conducted when the banker does not fold.

Next, in step S112, the gaming machine 1 determines, in step S111, whether or not the number of the players determined to have hands equal to or higher than Full House is equal to or more than 2. When determining that the number of the players determined to have hands equal to or higher than Full House is equal to or more than 2, the gaming machine 1 shifts the processing to step S115. On the other hand, when determining that the number of the players determined to have hands equal to or higher than Full House, is smaller than two, the gaming machine 1 shifts the processing to step S113.

In step S113, the gaming machine 1 determines whether or not the number of players determined, in step S111, to have hands equal to or higher than Full House is one. When determining that the number of players determined to have hands equal to or higher than Full House is not one, the gaming machine 1 ends the present subroutine. On the other hand, when determining that the number of the players determined to have hands equal to or higher than Full House is one, the gaming machine 1 shifts the processing to step S114.

In step S114, the gaming machine 1 conducts processing relating to the payout.

More specifically, the CPU 41 in the main control portion 40 transmits side BET payout information to the station 3, based on the hand strength of the player who is determined to have the hand equal to or higher than Full House. More specifically, the CPU 41 transmits information, as side BET payout information, indicative of the credit of the normal payout value determined based on the hand strength of this player.

On receiving the side BET payout information transmitted from the CPU 41, the CPU 51 in the station 3 stores, in the RAM 52, credit data based on the side BET payout information. Then, the CPU 51 pays out a credit based on the side BET payout information.

After conducting the processing in step S114, the gaming machine 1 ends the present subroutine.

The processing conducted by the main control portion 40 and the microcomputer 55 in the station 3 in step S114 corresponds to step (d) when determining, in the step (c), that the number of the players determined to have hands of said player's cards which satisfy the predetermined condition is one, determining a normal payout value which is determined based on this hand and the side BET, as a payout to be offered to the player, according to the present invention.

The normal payout value according to the present invention is determined based on the hand of the player determined to have the hand which satisfies the predetermined condition, and the side BET. In this case, the normal payout value based on the player's hand and the side BET according to the present embodiment refers to the following.

First, the normal payout value according to the present embodiment is determined based on the hand strength, as previously described. Namely, when the player's hand is Royal Flush, the value of the cumulative pot value is paid out in full to the player. When the player's hand is Straight Flush, 10% value of the cumulative pot value is paid out to the player. When the player's hand is Four of a kind, 500 dollars are paid out to the player. When the player's hand is Full House, 100 dollars are paid out to the player. As described above, in the present embodiment, when the player's hand is Royal Flush or Straight Flush, the normal payout value is the value resulting from multiplying the cumulative pot value by a predetermined rate. Further, when the player's hand is Four of a kind or Full House, the normal payout value is a predetermined value. Namely, in the present embodiment, there are two cases according to the type of the player's hand, where the normal payout value is the value resulting from multiplying the cumulative pot value by the predetermined rate, or the normal payout value is the predetermined value. However, the normal payout value according to the present invention may be the value resulting from multiplying the cumulative pot value by the predetermined rate, with regard to all hands for which payouts are to be offered. Also, the normal payout value according to the present invention may be the predetermined value, with regard to all hands for which payouts are to be offered.

On the other hand, the normal payout value according to the present embodiment being determined based on the side BET refers to the following. Namely, in the present embodiment, the normal payout value may be paid out when the side BET is placed. On the other hand, when no side BET is placed, there is no possibility that the normal payout value is paid out (namely, the normal payout value is 0). Within this meaning, it is possible to say that the normal payout value according to the present embodiment is determined based on the side BET.

Further, in the present embodiment, only the predetermined value (1 dollar) can be betted as the side BET. However, in the present invention, an arbitrary value may be betted as the side BET. In this case, the normal payout value may be determined based on the amount of the side BET value.

When determining that, in step S112, the number of the players determined to have hands equal to or higher than Full House is equal to or more than two (step S112: Yes), the gaming machine 1 compares the strength of hands among the plurality of players determined to have hands equal to or higher than Full House (step S115). More specifically, the CPU 41 in the main control portion 40 compares the strength of hands of five cards displayed to the liquid crystal displays 10 included in the stations 3 at which each player is playing the game, based on the strength ranking of hands.

Next, in step S116, the gaming machine 1 determines a winner. More specifically, the CPU 41 in the main control portion 40 determines the player who is playing the game at the station 3 which includes the liquid crystal display 10 displaying the strongest hand, to be a winner, based on the result of the comparison in step S115.

Next, in step S117, the gaming machine 1 conducts processing relating to the payout.

More specifically, the CPU 41 in the main control portion 40 transmits side BET payout information to the station 3, based on the hand strength of the winner determined in step S116. More specifically, the CPU 41 transmits information, as side BET payout information, indicative of the credit of the normal payout value determined based on the hand strength of the winner.

On receiving the side BET payout information transmitted from the CPU 41, the CPU 51 in the station 3 stores, in the RAM 52, credit data based on the side BET payout information. Then, the CPU 51 pays out the credit based on the side BET payout information.

After conducting the processing in step S117, the gaming machine 1 ends the present subroutine.

The processing conducted by the main control portion 40 and the microcomputer 55 in the station 3 in step S117 corresponds to the step (e) when determining, in the step (c), that the number of the players determined to have hands of the player's cards which satisfy the predetermined condition is equal to or more than two, determining payouts to be offered to the players, so as to make a total sum of the payout values to the players be smaller than a total sum of normal payout values to the players, according to the present invention.

In the present embodiment, when the player has the hand equal to or higher than Full House, he or she has a possibility to acquire the payout (a normal payout value) relating to the side BET. However, when a plurality of players has the hand equal to or higher than Full House, the normal payout value is paid out only to the winner. Therefore, when employing the present embodiment, the total sum of the payouts to the players is reduced, compared to the case where normal payout values are paid out to all players, when the plurality of players has a hand equal to or higher than Full House.

As described above, in the present embodiment, a method of determining a single player having the strongest hand based on the hand strength and offering the payout only to this player, is employed as a method for reducing the total sum of payouts to players.

However, in the present invention, the method to reduce the total sum of payouts to the players is not necessarily required to be based on the hand strength. For example, by determining the winner based on a certain standard such as the strength of the high card, the normal payout value may be paid out only to this winner.

Further, in the present invention, the method for reducing the total sum of payouts to the players is not limited to the method of offering the payout only to the winner. For example, the payout may be offered only to the player having the second strongest hand.

Further, in the present invention, the method for reducing the total sum of payouts to the players is not necessarily required to be based on a rule of some sort. The player to whom the payout is to be offered may be selected at random from players satisfying the predetermined condition.

Further, in the present invention, when the number of the players having hands of player's cards satisfying a predetermined condition is equal to or more than two, the number of the players who can acquire normal payout values is not limited to one. In this case, the number of the players who can acquire normal payout values is not particularly limited, as long as this number is smaller than the number of the players determined to have hands satisfying the predetermined condition. For example, normal payout values may be offered to the number of players, which number is resulting from subtracting 1 from the number of players having hands satisfying the predetermined condition. Also, comparing the strength of hands among the players having hands satisfying the predetermined condition, normal payout values may be paid out to the players having hands of the odd-numbered strength ranking.

When employing this structure, the total sum of the payouts to the players can be reduced, compared to the case where normal payout values are paid out to all players, when the plurality of players have hands satisfying the predetermined condition.

There has been described the embodiment of the present invention.

While, in the present embodiment, there has been described a case where the card game is played using the gaming machine 1, the card game may be played without using a gaming machine (for example, a banker and a player play a game around an actual table) in the present invention.

Further, in the present embodiment, there has been described a case where a dealer serves as a banker. In the present invention, however, a single player may serve as a banker.

Further, in the present embodiment, there has been described a case where Caribbean stud poker is played as a card game, a card game to be played in the present invention is not particularly limited. The numbers of player's cards and banker's cards are also changeable as appropriate.

Further, in the present embodiment, there has been described a case where playing cards are used to play a game. However, the cards (player's cards and banker's cards) according to the present invention are not limited to playing cards, but may be, for example, tarot cards.

Further, in the present embodiment, there has been described a case where players play Caribbean stud poker by viewing the main monitor 2 and the liquid crystal displays 10 included in the stations, the gaming machine according to the present invention is only required to include either a main monitor or liquid crystal displays (displays included in the stations). In the case of this structure, the dealer's cards (the banker's cards) and the player's cards may be displayed together to the main monitor or the displays in the stations.

Although the present invention has been described with reference to embodiments thereof, these embodiments merely illustrate concrete examples, not restrict the present invention. The concrete structures of respective means and the like can be designed and changed as required. Furthermore, there have been merely described most preferable effects of the present invention, as the effects of the present invention, in the embodiments of the present invention. The effects of the present invention are not limited to those described in the embodiments of the present invention.

Further, in the aforementioned detailed description, characteristic portions have been mainly described, for ease of understanding the present invention. The present invention is not limited to the embodiments described in the aforementioned detailed description, but can be also applied to other embodiments over a wider range of applications. Further, the terms and phrases used in the present specification have been used for clearly describing the present invention, not for limiting the interpretation of the present invention. Further, those skilled in the art will easily conceive other structures, systems, methods and the like which are included in the concept of the present invention, from the concept of the present invention described in the present specification. Accordingly, the description of the claims is intended to include equivalent structures that fall within the technical scope of the invention. Further, the abstract aims at enabling engineers and the like who belong to the present technical field but are not familiar with the patent office and public institutions, the patent, law terms and technical terms to immediately understand the technical content and the essence of the present application through brief studies. Accordingly, the abstract is not intended to restrict the scope of the invention which should be evaluated from the description of the claims. It is desirable that literatures and the like which have been already disclosed are sufficiently studied and understood, in order to sufficiently understand the objects of the present invention and the specific effects of the present invention.

In the aforementioned detailed description, there have been described processes to be executed by computers. The aforementioned description and expressions have been described for the sake of enabling those skilled in the art to understand the present invention most effectively. In the present specification, each step for deriving a single result should be understood to be self-consistent processing. Further, each step includes transmission, reception, recording and the like of electric or magnetic signals. Although, in the processing at each step, such signals have been expressed as bits, values, symbols, characters, terms, numerical characters and the like, it should be noticed that they have been merely used for convenience of description. Further, although the processing at each step was described using expressions common to human behaviors in some cases, the processes described in the present specification are to be executed by various types of devices, in principle. Further, other structures required for conducting each step will be apparent from the aforementioned description.

What is claimed as new and desired to be secured by Letters Patent of the United States is:

1. A playing method of a card game comprising the steps of:
(a) dealing a predetermined number of cards to a plurality of players as player's cards and dealing a predetermined number of cards to a banker as banker's cards;
(b) placing a side BET different from a normal BET;
(c) determining whether or not a hand of said player's cards dealt to a player who has placed said side BET, satisfies a predetermined condition;
(d) when determining, in said step (c), that the number of the players determined to have hands of said player's cards which satisfy said predetermined condition is one, determining a normal payout value which is determined based on this hand and said side BET, as a payout to be offered to the player; and
(e) when determining, in said step (c), that the number of the players determined to have hands of said player's cards which satisfy said predetermined condition is equal to or more than two, determining payouts to be offered to those players, so as to make a total sum of the payout values to those players be smaller than a total sum of normal payout values to those players.

2. The playing method of a card game according to claim 1,
wherein
said predetermined condition is a condition that the strength of the hand of player's cards should be equal to or higher than a standard predetermined in an order of the hand strength, and
said step (e) is a step of,
when determining, in said step (c), that the number of the players determined to have hands of player's cards which satisfy said predetermined condition is equal to or more than two, determining the player having the strongest hand by comparing hands of those players based on said order of the hand strength, and determining the normal payout value which is determined based on this hand and said side BET, as the payout to be offered to the player.

3. The playing method of a card game according to claim 1, comprising a step of:
(b′) determining whether or not the banker should fold, after said step (b) and before said step (c), and
said step (c) is a step of:
determining whether or not the hand of said player's cards dealt to the player who has placed said side BET, satisfies said predetermined condition, on condition that a determination is made in said step (b′) that the banker should fold.

4. The playing method of a card game according to claim 3, comprising the steps of:
(a′) placing an entry-fee BET before said step (a); and
(b″) offering a payout to a player who has not placed said side BET, based on said inputted entry-fee BET, when determining that the banker should fold in said step (b′), after said step (b′) and before said step (c).

5. A gaming machine comprising:
a display capable of displaying a plurality of cards;
a plurality of input devices capable of being operated by a plurality of players; and
a controller,
said controller programmed to conduct the processing of:
(a) displaying a predetermined number of player's cards and a predetermined number of banker's cards to said display;
(b) accepting an input of a side BET different from a normal BET from each of said input devices;
(c) determining whether or not a hand of said player's cards of a player who has inputted said side BET, satisfies a predetermined condition;
(d) when determining, in said step (c), that the number of the players determined to have hands of said player's cards which satisfy said predetermined condition is one, determining a normal payout value which is determined based on this hand and said side BET, as a payout to be offered to the player; and
(e) when determining, in said step (c), that the number of the players determined to have hands of said player's cards which satisfy said predetermined condition is equal to or more than two, determining payouts to be offered to those players, so as to make a total sum of the payouts to be offered to those players be smaller than a total sum of normal payout values to those players.

6. The gaming machine according to claim 5,
wherein
said predetermined condition is a condition that the strength of the hand of player's cards should be equal to or higher than a standard predetermined in an order of the hand strength, and
said processing (e) is a processing of:
when determining, in said processing (c), that the number of the players determined to have hands of player's cards which satisfy said predetermined condition is equal to or more than two, determining the player having the strongest hand by comparing the hands of the players based on said order of the hand strength, and determining the normal payout value which is determined based on this hand and said side BET, as the payout to be offered to the player.

7. The gaming machine according to claim 5,
wherein
said controller is further programmed to conduct a processing of:
(b′) determining whether or not the banker should fold, after said processing (b) and before said processing (c), and
said processing (c) is a processing of:
determining whether or not the hand of said player's cards of the player who has inputted said side BET, satisfies said predetermined condition, on condition that a determination is made in said processing (b′) that the banker should fold.

8. The gaming machine according to claim 7,
wherein
said controller is further programmed to conduct the processing of:
(a′) accepting an input of an entry-fee BET from each of said input devices, before said processing (a); and
(b″) offering a payout to a player who has not inputted said side BET, based on said inputted entry-fee BET, when determining that the banker should fold in said processing (b′), after said processing (b′) and before said processing (c).
